(19) United States
(12) Patent Application Publication
(10) Pub. No.: US 2024/0170229 A1
(43) Pub. Date: May 23, 2024

(54) POWER STORAGE MODULE AND MANUFACTURING METHOD FOR POWER STORAGE MODULE

(71) Applicant: Panasonic Intellectual Property Management Co., Ltd., Osaka (JP)

(72) Inventors: Yuichi TASHIRO, Kyoto (JP); Kiyoshi WAKINAKA, Osaka (JP); Toru KOBAYASHI, Kyoto (JP)

(21) Appl. No.: 18/283,730

(22) PCT Filed: Mar. 17, 2022
(86) PCT No.: PCT/JP2022/012121

§ 371 Date: Sep. 22, 2023

(30) Foreign Application Priority Data
Mar. 25, 2021 (JP) 2021-052441

(51) Int. Cl. H01G 11/78; H01G 11/10; H01G 11/84; H01M 50/213; H01M 50/244; H01M 50/271; H01M 50/284; H01M 50/296

(52) U.S. Cl. CPC H01G 11/78; H01G 11/10; H01G 11/84; H01M 50/213; H01M 50/244; H01M 50/271; H01M 50/284; H01M 50/296

(57) ABSTRACT

A power storage module includes: a plurality of power storage devices, a hold case, a board, and a plurality of connection terminals for electrically connecting the plurality of power storage devices and the board to each other. The board includes a plurality of first through-holes provided so as to respectively correspond to the connection terminals. Each of the connection terminals includes a terminal connection part which is connected to a positive electrode lead terminal or a negative electrode lead terminal, and a board connection part which is connected to the board. The board connection part: has a size larger than that of each first through-hole and is elastically deformable; and is present, in the first through-hole, in a state of being elastically deformed so as to have the same size as the diameter of the first through-hole, and presses the inner wall face first through-hole.

### CROSS-REFERENCE TO RELATED APPLICATIONS

This application is the U.S. National Phase under 35 U.S.C. § 371 of International Patent Application No. PCT/JP2022/012121, filed on Mar. 17, 2022, which in turn claims the benefit of Japanese Patent Application No. 2021-052441, filed on Mar. 25, 2021, the entire content of each of which is incorporated herein by reference.

### TECHNICAL FIELD

The present invention relates to a power storage module and a manufacturing method for the power storage module.

### BACKGROUND ART

Patent Literature 1 describes a power storage module that includes: a plurality of power storage devices each having a terminal part at an end face; a holder in which the plurality of power storage devices are held so as to be arranged such that the peripheral faces of the respective power storage devices are adjacent to each other; a circuit board disposed such that a board face thereof is opposed to the peripheral faces of the plurality of power storage devices; and a plurality of bus bars that electrically connect the plurality of power storage devices and the circuit board to each other.

In the power storage module of Patent Literature 1, in the circuit board, a plurality of through-holes are formed so as to correspond to the respective bus bars. Each bus bar includes a terminal connection part which is connected to the terminal part, and a board connection part which is connected to the circuit board. The board connection part is passed through a through-hole, and then is electrically connected to the through-hole by soldering.

### CITATION LIST

### Patent Literature

[PTL 1] International Publication No. WO 2020/203734

### SUMMARY OF THE INVENTION

In the power storage module of Patent Literature 1, if the board connection part and the through-hole can be electrically connected without performing soldering, the soldering step can be omitted when manufacturing the power storage module.

In view of the above problem, an object of the present invention is to provide a power storage module and a manufacturing method for the power storage module that are capable of electrically connecting a power storage device and a board to each other without performing soldering.

A first aspect of the present invention relates to a power storage module. The power storage module according to the present aspect includes: a plurality of power storage devices each having a terminal at an end face thereof; a holder in which the plurality of power storage devices are held so as to be arranged such that peripheral faces of the respective power storage devices are adjacent to each other; a board disposed such that a plate face thereof is opposed to the peripheral faces of the plurality of power storage devices; and a plurality of connection terminals for electrically connecting the plurality of power storage devices and the board to each other. Here, the board includes a plurality of through-holes provided so as to respectively correspond to the connection terminals. Each of the connection terminals includes a terminal connection part which is connected to the terminal, and a board connection part which is connected to the board. The board connection part: has a size larger than a diameter of each through-hole and is elastically deformable; and is present, in the through-hole, in a state of being elastically deformed so as to have a same size as the diameter of the through-hole, and presses an inner wall face of the through-hole.

A second aspect of the present invention relates to a manufacturing method for a power storage module including a plurality of power storage devices each having a terminal at an end face thereof, a holder in which the plurality of power storage devices are held so as to be arranged such that peripheral faces of the respective power storage devices are adjacent to each other, a board disposed such that a plate face thereof is opposed to the peripheral faces of the plurality of power storage devices, and a plurality of connection terminals for electrically connecting the plurality of power storage devices and the board to each other. In the manufacturing method according to the present aspect, the board includes a plurality of through-holes provided so as to respectively correspond to the connection terminals, and each of the connection terminals includes a board connection part having a size larger than a diameter of each through-hole and being elastically deformable. When the plurality of connection terminals are to be connected to the board, the board connection part is press-fitted into the through-hole, to be elastically deformed so as to reduce the size of the board connection part in a radial direction of the through-hole, to be brought into contact with an inner wall face of the through-hole.

According to the present invention, it is possible to provide a power storage module and a manufacturing method for the power storage module that are capable of electrically connecting a power storage device and a board without performing soldering.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1 is a perspective view of a power storage module according to an embodiment.

FIG. 2 is a perspective view of the power storage module in a state where a cover is removed, according to the embodiment.

FIG. 3 is a perspective view of the power storage module in a state where the cover and a board are removed, according to the embodiment.

FIG. 4 is a perspective view of a power storage device according to the embodiment.

FIG. 5 is a perspective view of a hold case according to the embodiment.

FIG. 6 shows the hold case viewed from the front of a fourth lateral face part, according to the embodiment.

FIG. 7A is a perspective view of a main part of the hold case showing surroundings of one set of connection terminals and columnar parts, according to the embodiment. FIG. 7B is a perspective view of a connection terminal according to the embodiment.

FIG. 8 is a perspective view of a main part of the hold case showing surroundings of one set of connection terminals and columnar parts, in a state where a power storage device is attached, according to the embodiment.

FIG. 9A is a perspective view of a main part of the hold case showing surroundings of one first mounting part, according to the embodiment. FIG. 9B is a perspective view of a connection body according to the embodiment.

FIG. 10A is a plan view of a main part of the hold case showing surroundings of a connector, according to the embodiment.

FIG. 10B is a perspective view of six connector terminals forming the connector, according to the embodiment.

FIG. 11A is a cross-sectional view of a main part along a line A-A′ in FIG. 2, according to the embodiment. FIG. 11B is a cross-sectional view of a main part along a line B-B′ in FIG. 2, according to the embodiment.

FIG. 12 is a cross-sectional view of a main part along a line C-C′ in FIG. 2, according to the embodiment.

FIG. 13 is a perspective view of the cover according to the embodiment.

FIG. 14 is a cross-sectional view of the power storage module along a line D-D′ in FIG. 1, according to the embodiment.

FIG. 15A is an end view of a main part of the power storage module along a Y-Z plane at an engagement position between a first projection and a first recess, according to the embodiment.

FIG. 15B is an end view of a main part of the power storage module along a Y-Z plane at an engagement position between a second projection and a second recess, according to the embodiment. FIG. 15C is an end view of a main part of the power storage module along an X-Z plane at an engagement position between a third projection and a third recess, according to the embodiment.

FIG. 16A is a diagram for describing connection between a connection part of a first mounting part and a hole in the board, according to the embodiment. FIG. 16B is a diagram for describing connection between a board connection part of a connection terminal and a first through-hole in the board, according to the embodiment.

FIG. 17A is a diagram for describing a configuration of a terminal holding part according to a modification. FIG. 17B is a diagram for describing a configuration of a board connection part of a connection terminal, according to a modification. FIG. 17C is a diagram for describing a configuration of a connection part of a first mounting part, according to a modification.

### BEST MODE FOR CARRYING OUT THE INVENTION

Hereinafter, a power storage module 1 according to the present embodiment will be described with reference to the drawings. For convenience, in each drawing, X, Y, and Z-axes orthogonal to each other are shown. The Z-axis direction is the direction (the direction in which power storage devices 100 and a board 300 are arranged) in which a hold case 200 is open.

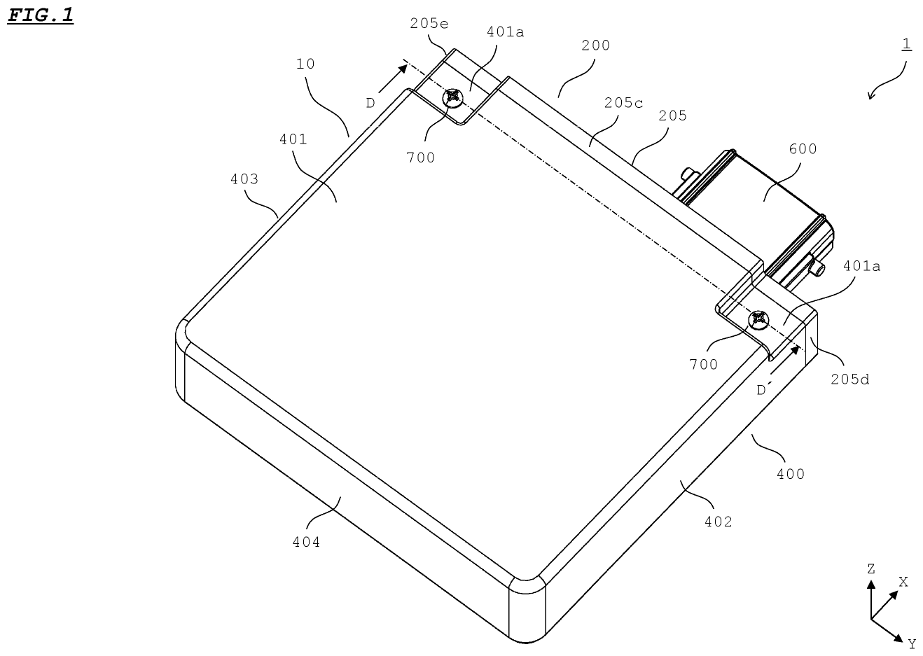

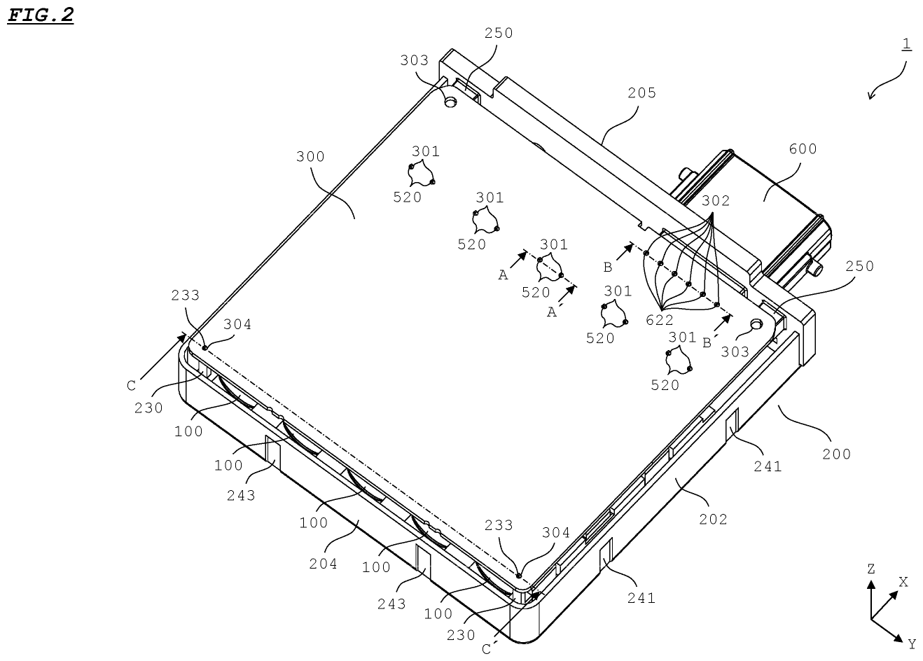

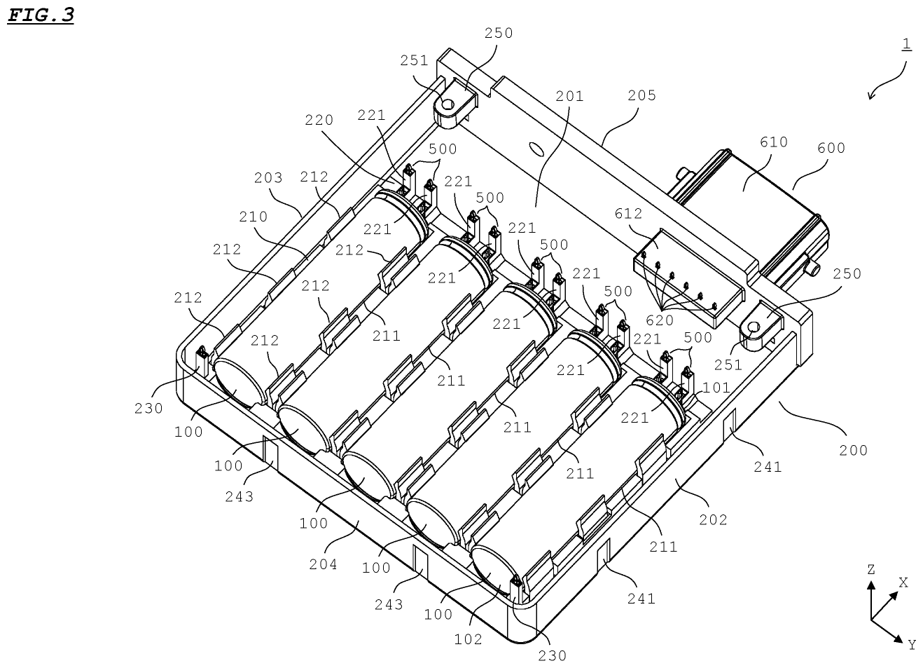

FIG. 1 is a perspective view of the power storage module 1. FIG. 2 is a perspective view of the power storage module 1 in a state where a cover 400 is removed. FIG. 3 is a perspective view of the power storage module 1 in a state where the cover 400 and the board 300 are removed.

The power storage module 1 is used in various electronic apparatuses, electric apparatuses, industrial apparatuses, automobiles, and the like, and provides assistance, backup, and the like of electric power. For example, when the power storage module 1 is mounted to an automobile, the power storage device 100 can be charged by electric power supplied by a battery of the automobile.

With reference to FIG. 1 to FIG. 3, the power storage module 1 includes five power storage devices 100, the hold case 200, the board 300, and the cover 400.

The hold case 200 is a holder and holds the five power storage devices 100. The five power storage devices 100 are held, in a holding part 210 provided in the hold case 200, so as to be arranged such that peripheral faces 103 of the respective power storage devices 100 are adjacent to each other.

The board 300 is disposed such that the plate face thereof is opposed to the peripheral faces 103 of the five power storage devices 100. The five power storage devices 100 and the board 300 are electrically connected to each other by ten connection terminals 500.

A connector 600, which is an output part for outputting electric power of the five power storage devices 100 to the outside, is provided to the hold case 200. Connector terminals 620 of the connector 600 are electrically connected to the board 300. Electric power of the five power storage devices 100 is outputted to the outside via the board 300 and the connector 600. Further, electric power for charging the five power storage devices 100 is inputted to the board 300 via the connector 600.

The cover 400 is attached to the hold case 200 and fixed to the hold case 200 by two screws 700. The hold case 200 and the cover 400 form an exterior case 10 in which the five power storage devices 100 and the board 300 are housed.

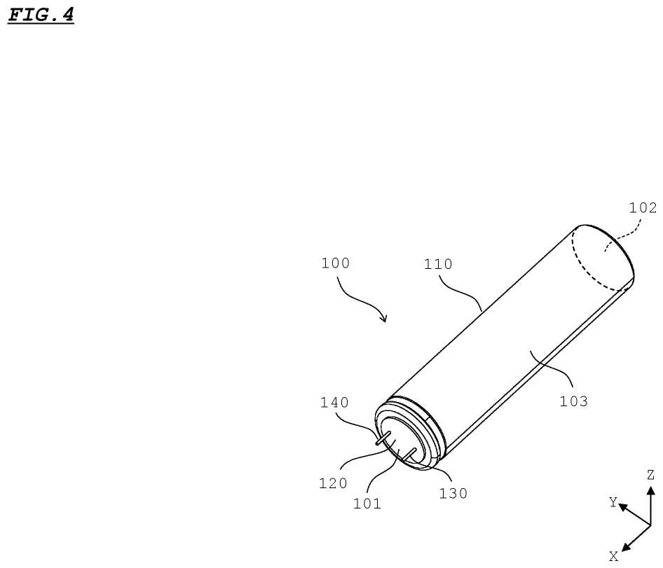

FIG. 4 is a perspective view of a power storage device 100.

Each power storage device 100 is an electric double layer capacitor, for example. The power storage device 100 may be a capacitor, such as a lithium ion capacitor, other than the electric double layer capacitor. A power storage device 100 in which a conductive polymer is used as an active material of the positive electrode may be adopted. Examples of the conductive polymer include polyaniline, polypyrrole, polythiophene, derivatives thereof, and the like. A plurality of types of conductive polymers may be used.

Each power storage device 100 includes: an exterior case 110 having a slender bottomed circular cylindrical shape and containing a device element (not shown) and an electrolytic solution; a sealing body 120 which is formed from an elastic material containing a rubber component and which seals the opening of the exterior case 110; and a positive electrode lead terminal 130 and a negative electrode lead terminal 140 which each have a round bar shape and which are drawn from the sealing body 120 to the outside. The positive electrode lead terminal 130 is electrically connected to the positive electrode of the device element, and the negative electrode lead terminal 140 is electrically connected to the negative electrode of the device element. The positive electrode lead terminal 130 and the negative electrode lead terminal 140 are a pair of terminals for outputting electric power from the power storage device 100.

The sealing body 120 forms a first end face 101 of the power storage device 100, the bottom face of the exterior case 110 forms a second end face 102 of the power storage device 100, and the peripheral face of the exterior case 110 forms a peripheral face 103 of the power storage device 100. The positive electrode lead terminal 130 and the negative electrode lead terminal 140 are provided at the first end face 101, protrude from the first end face 101, and linearly extend. Hereinafter, the positive electrode lead terminal 130 and the negative electrode lead terminal 140 may be collectively referred to as a pair of lead terminals 130, 140.

In the present embodiment, the power storage device 100 has a circular cylindrical shape, but may have a polygonal cylindrical shape. When the power storage device 100 has a circular cylindrical shape, the peripheral face thereof is a circular cylinder, and when the power storage device 100 has a polygonal cylindrical shape, the peripheral face thereof is a polygonal cylinder.

The direction of the central axis of the power storage device 100 having the cylindrical shape is the axis direction of the power storage device 100, and the in-plane direction perpendicular to the axis direction is the radial direction of the power storage device 100.

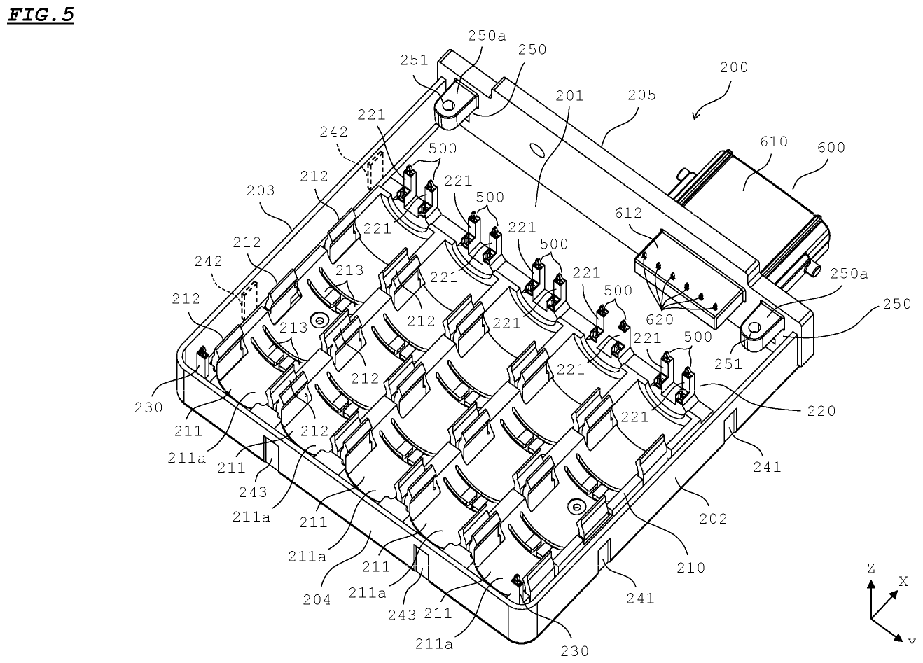

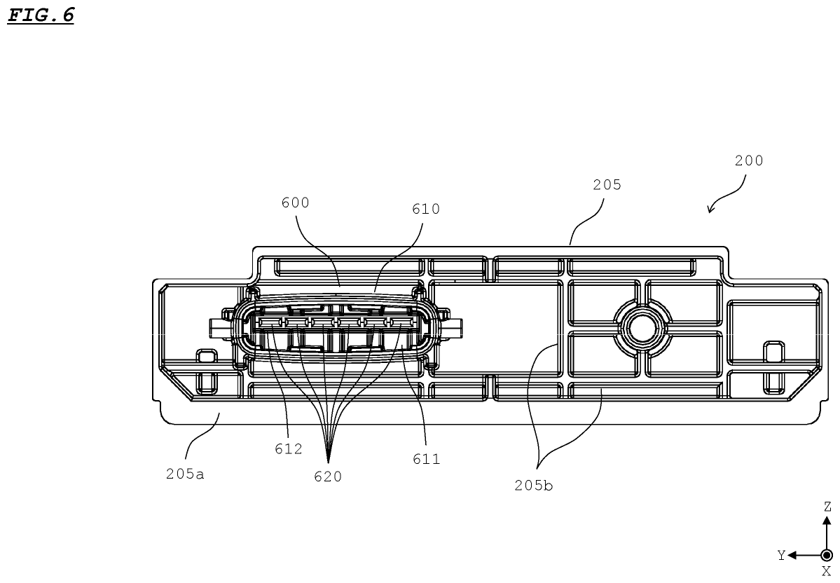

FIG. 5 is a perspective view of the hold case 200. FIG. 6 shows the hold case 200 viewed from the front of a fourth lateral face part 205.

The hold case 200 is formed from a resin material, e.g., a thermoplastic resin such as polybutylene terephthalate (PBT) or polyphenylene sulfide (PPS). The hold case 200 has a box shape of a quadrangular shape that is flat in the Z-axis direction in which one face thereof is open.

The hold case 200 includes: a bottom face part 201 having a quadrangular shape; a first lateral face part 202 and a second lateral face part 203 which have quadrangular shapes and which stand from two sides, that are parallel to each other in the Y-axis direction, of the bottom face part 201; and a third lateral face part 204 and the fourth lateral face part 205 which have quadrangular shapes and which stand from two sides, that are parallel to each other in the X-axis direction, of the bottom face part 201. A face of the hold case 200 opposed to the bottom face part 201 is open. The first lateral face part 202 is positioned on the Y-axis positive direction side, and the second lateral face part 203 is positioned on the Y-axis negative direction side. The third lateral face part 204 is positioned on the X-axis negative direction side, and the fourth lateral face part 205 is positioned on the X-axis positive direction side.

The fourth lateral face part 205 has a height, from the bottom face part 201, that is larger than those of the first lateral face part 202, the second lateral face part 203, and the third lateral face part 204. Both end faces in the Y-axis direction of the fourth lateral face part 205 slightly protrude to the outer side relative to the first lateral face part 202 and the second lateral face part 203. Further, in the fourth lateral face part 205, both end portions in the Y-axis direction thereof are slightly lower than the center portion thereof. Further, the fourth lateral face part 205 has, at the outer face thereof, a rib 205a extending along the outer peripheral edge, and a plurality of ribs 205b extending in the vertical direction and the lateral direction. The thickness of the fourth lateral face part 205 is, as a whole, larger than the thicknesses of the first lateral face part 202, the second lateral face part 203, and the third lateral face part 204. Accordingly, the fourth lateral face part 205 has a strength higher than those of the first lateral face part 202, the second lateral face part 203, and the third lateral face part 204.

As shown in FIG. 5, the bottom face part 201 is provided with the holding part 210 in which the five power storage devices 100 are held. The holding part 210 has a width substantially the same as that of the bottom face part 201 in the Y-axis direction, and a width smaller than that of the bottom face part 201 in the X-axis direction, and is positioned closer to the third lateral face part 204 side. The holding part 210 is formed integrally with the bottom face part 201. In the present embodiment, the holding part 210 is formed on the bottom face part 201. However, as long the bottom face part 201 has the holding part 210, the holding part 210 may be formed so as to be a part of the bottom face part 201.

In the holding part 210, five accommodation parts 211 are formed so as to be arranged in the Y-axis direction. Each accommodation part 211 is recessed in a substantially semicircular arc shape so as to be able to accommodate substantially half of the peripheral face 103 of a corresponding power storage device 100, and has a holding face 211a having a circular arc shape. In the holding part 210, pairs of claw parts 212 are provided at three places in the X-axis direction, on both sides in the Y-axis direction of each accommodation part 211. Each claw part 212 is curved so as to have a curvature close to that of the holding face 211a, and protrudes to the inner side of the accommodation part 211. In the holding part 210, pairs of claw parts 213 are provided at two places, also on the holding face 211a of each accommodation part 211. Protrusions at the leading ends of each pair of claw parts 213 slightly protrude from the holding face 211a into the accommodation part 211.

As shown in FIG. 3, each power storage device 100 is held in a corresponding accommodation part 211 so as to be sandwiched by the pairs of claw parts 212 at the three places and the pairs of claw parts 213 at the two places. In each power storage device 100, the first end face 101 having the pair of lead terminals 130, 140 faces the fourth lateral face part 205 so as to be oriented in the X-axis positive direction, and the second end face 102 faces the third lateral face part 204 so as to be oriented in the X-axis negative direction.

As shown in FIG. 5, in the bottom face part 201, a terminal holding part 220 which holds the ten connection terminals 500 is provided at a position on the X-axis positive direction side of the five accommodation parts 211 in the holding part 210. The terminal holding part 220 includes ten L-shaped columnar parts 221 standing from the holding part 210. The ten columnar parts 221 are arranged with an interval therebetween in the direction (the Y-axis direction) in which the five accommodation parts 211, i.e., the five power storage devices 100, are arranged. The ten columnar parts 221 each hold a corresponding connection terminal 500.

The ten columnar parts 221 are in sets which are each composed of two columnar parts 221, and one set of the columnar parts 221 corresponds to one accommodation part 211. One set of the connection terminals 500 held in one set of the columnar parts 221 corresponds to a pair of lead terminals 130, 140 of each power storage device 100.

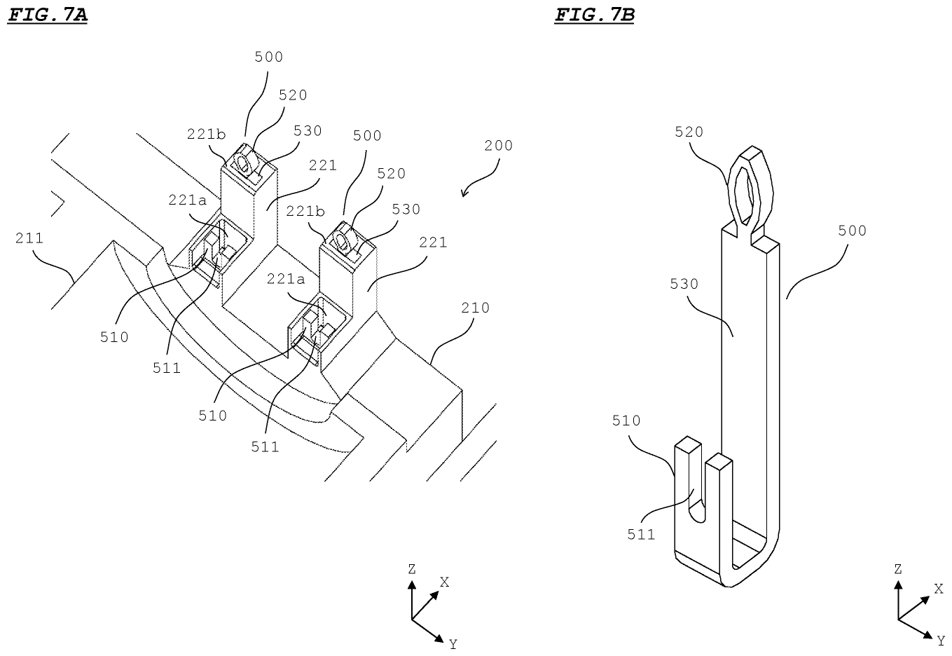

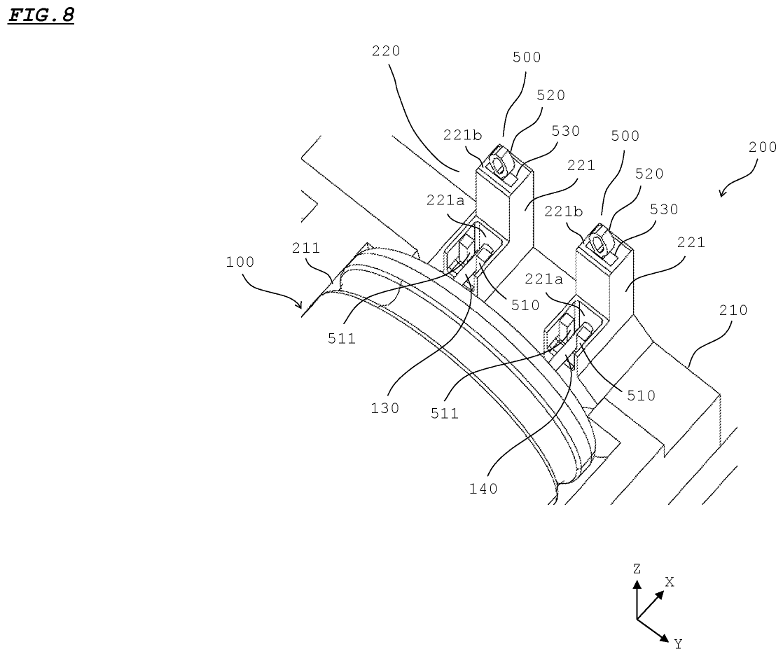

FIG. 7A is a perspective view of a main part of the hold case 200 showing surroundings of one set of the connection terminals 500 and the columnar parts 221. FIG. 7B is a perspective view of a connection terminal 500. FIG. 8 is a perspective view of a main part of the hold case 200 showing surroundings of one set of the connection terminals 500 and the columnar parts 221, in a state where a power storage device 100 is attached.

As shown in FIG. 7B, each connection terminal 500 is formed from a material having conductivity, e.g., a metal material such as copper, and includes: a terminal connection part 510 to be connected to a positive electrode lead terminal 130 or a negative electrode lead terminal 140; a board connection part 520 to be connected to the board 300; and a relay part 530 continuous between the terminal connection part 510 and the board connection part 520.

The terminal connection part 510 has a quadrangular plate shape. In the terminal connection part 510, a slit-like groove part 511 is formed in the Z-axis direction. The groove part 511 has a width smaller, to such an extent that the lead terminal 130, 140 can be press-fitted therein, than the diameter of the positive electrode lead terminal 130 or the negative electrode lead terminal 140. The groove part 511 is open in the Z-axis positive direction. The board connection part 520 has a ring shape of a spindle shape (lemon shape) and is elastically deformable so as to be compressed in the Y-axis direction. The relay part 530 has an L-shaped plate shape. The relay part 530 extends in the X-axis positive direction from an end portion in the z-axis negative direction of the terminal connection part 510, and then is bent to extend in the Z-axis positive direction to be continuous to the board connection part 520. That is, the board connection part 520 is provided at an end portion in the Z-axis positive direction of the relay part 530.

As shown in FIG. 7A, each connection terminal 500 is insert-molded in a corresponding columnar part 221. That is, with respect to the connection terminal 500, the relay part 530 is embedded inside the columnar part 221, the terminal connection part 510 is disposed in a recess 221a provided at a base portion of the columnar part 221, and the board connection part 520 protrudes from a leading end face 221b of the columnar part 221. The entirety of the relay part 530 need not necessarily be embedded in the columnar part 221, and a part of the relay part 530 may be exposed from the columnar part 221.

As shown in FIG. 8, the positive electrode lead terminal 130 and the negative electrode lead terminal 140 of the power storage device 100 are connected to the terminal connection parts 510 of the respectively corresponding connection terminals 500. At this time, the positive electrode lead terminal 130 and the negative electrode lead terminal 140 are fitted into the groove parts 511 of the terminal connection parts 510 by press-fitting from the Z-axis direction orthogonal to the X-axis direction in which these terminals protrude. Accordingly, the positive electrode lead terminal 130 and the negative electrode lead terminal 140, and the respectively corresponding terminal connection parts 510 are rigidly connected to each other.

As shown in FIG. 5, in the bottom face part 201, two first mounting parts 230 are respectively provided in the vicinity of a corner portion between the first lateral face part 202 and the third lateral face part 204, and in the vicinity of a corner portion between the second lateral face part 203 and the third lateral face part 204.

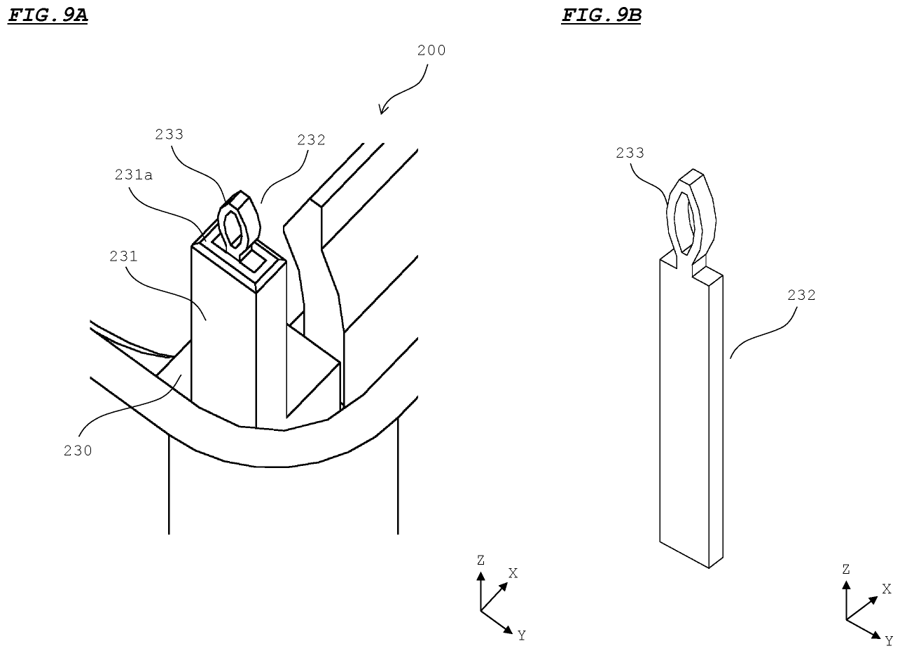

FIG. 9A is a perspective view of a main part of the hold case 200 showing surroundings of one first mounting part 230, and FIG. 9B is a perspective view of a connection body 232.

As shown in FIG. 9A each first mounting part 230 includes: a post part 231 standing from the holding part 210; and a connection body 232 made of metal and embedded in the post part 231 by insert molding. As shown in FIG. 9B, the connection body 232 has, at a leading end portion thereof, a connection part 233 to be connected to the board 300. The connection part 233 has a ring shape of a spindle shape (lemon shape) and is elastically deformable so as to be compressed in the Y-axis direction. The connection part 233 protrudes from a leading end face 231a of the post part 231.

As shown in FIG. 5, the first lateral face part 202, the second lateral face part 203, and the third lateral face part 204 are provided with, at two places on the outer face thereof, first recesses 241, second recesses 242, and third recesses 243, respectively, which each have a quadrangular shape.

As shown in FIG. 5, in the vicinity of the first lateral face part 202 and the vicinity of the second lateral face part 203 at the inner face of the fourth lateral face part 205, the fourth lateral face part 205 is provided with second mounting parts 250 to which the board 300 is mounted. The face oriented in the Z-axis positive direction of each second mounting part 250 serves as a mounting face 250a for the board 300. The height from the bottom face part 201 of the mounting face 250a is higher than the heights from the bottom face part 201 of the first lateral face part 202 and the second lateral face part 203. Each second mounting part 250 has a screw hole 251 in the mounting face 250a.

The connector 600 is formed integrally with the fourth lateral face part 205 so as to protrude from the outer face thereof.

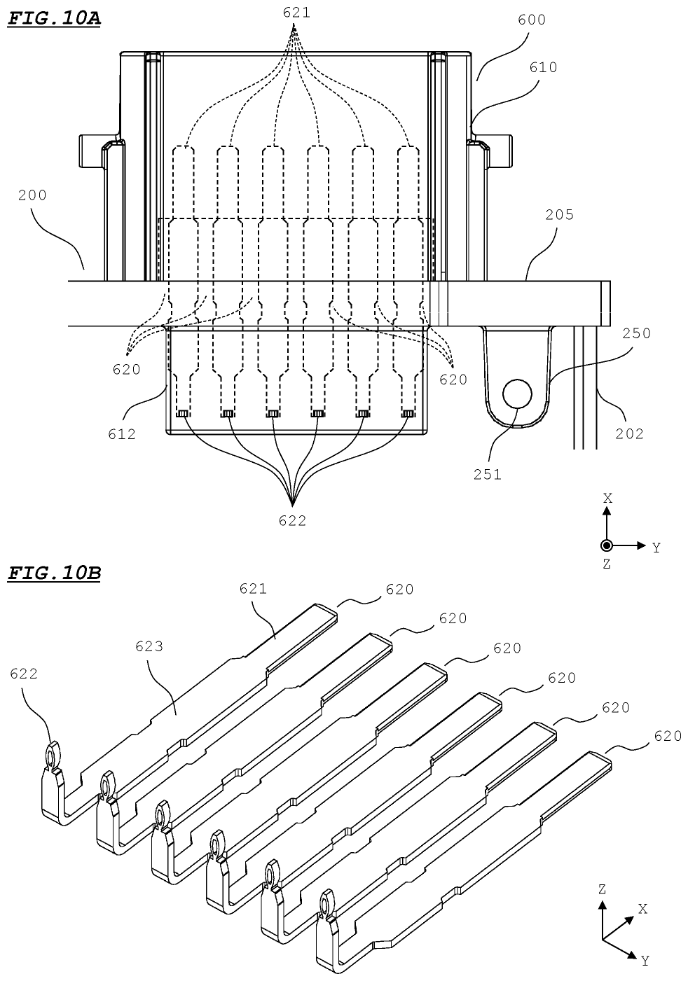

FIG. 10A is a plan view of a main part of the hold case 200 showing surroundings of the connector 600. FIG. 10B is a perspective view of six connector terminals 620 forming the connector 600.

As shown in FIG. 6 and FIG. 10A, the connector 600 includes a housing 610, and a plurality of, e.g., six, the connector terminals 620. The housing 610 has a box shape that is flat in the Z-axis direction and that is open in the X-axis positive direction. A part of the fourth lateral face part 205 is used in common as a bottom face part 611 of the housing 610. The housing 610 has, at the bottom face part 611, a terminal holding part 612 which protrudes in the X-axis direction relative to the outer face and the inner face of the fourth lateral face part 205, and which holds the six connector terminals 620.

As shown in FIG. 10B, each connector terminal 620 is formed from a material having conductivity, e.g., a metal material such as copper, and includes: a terminal connection part 621 to be connected to an external terminal; a board connection part 622 to be connected to the board 300; and a relay part 623 extending in the X-axis negative direction from the terminal connection part 621, and then bent to extend in the Z-axis positive direction to be continuous to the board connection part 622. The board connection part 622 has a ring shape of a spindle shape (lemon shape) and is elastically deformable so as to be compressed in the Y-axis direction.

The plurality of connector terminals 620 are disposed so as to be arranged in the Y-axis direction in the housing 610. Each relay part 623 is embedded in the terminal holding part 612 by insert molding. Each terminal connection part 621 protrudes in the X-axis positive direction from the terminal holding part 612 in the housing 610, and each board connection part 622 protrudes in the Z-axis positive direction from the terminal holding part 612, on the inner side of the fourth lateral face part 205.

As shown in FIG. 2, the board 300 is formed in a quadrangular shape, and has a size slightly smaller than that of the bottom face part 201 of the hold case 200. The board 300 is disposed on a side opposite to the bottom face part 201 with respect to the five power storage devices 100.

On the board 300, pattern wiring (not shown) for connecting the five power storage devices 100 in series or in parallel is formed. On the board 300, a charge circuit (not shown) for charging each power storage device 100 by supply of electric power from an external battery or the like is disposed. The charge circuit includes various electrical components such as a field effect transistor (FET) and pattern wiring that connects the various electrical components. A circuit other than the charge circuit, e.g., a balancing circuit that adjusts output voltage of the power storage devices 100, may be disposed on the board 300.

The board 300 has: ten (five sets) circular first through-holes 301 at positions corresponding to the ten (five sets) connection terminals 500; and six circular second through-holes 302 at positions corresponding to the six connector terminals 620. Each first through-hole 301 and each second through-hole 302 are formed by plating, with a metal such as copper, the inner wall face of a hole penetrating the board 300. The ten first through-holes 301 and the six second through-holes 302 have connected thereto the pattern wiring formed on the board 300.

The board connection part 520 of each connection terminal 500 is inserted in a corresponding first through-hole 301.

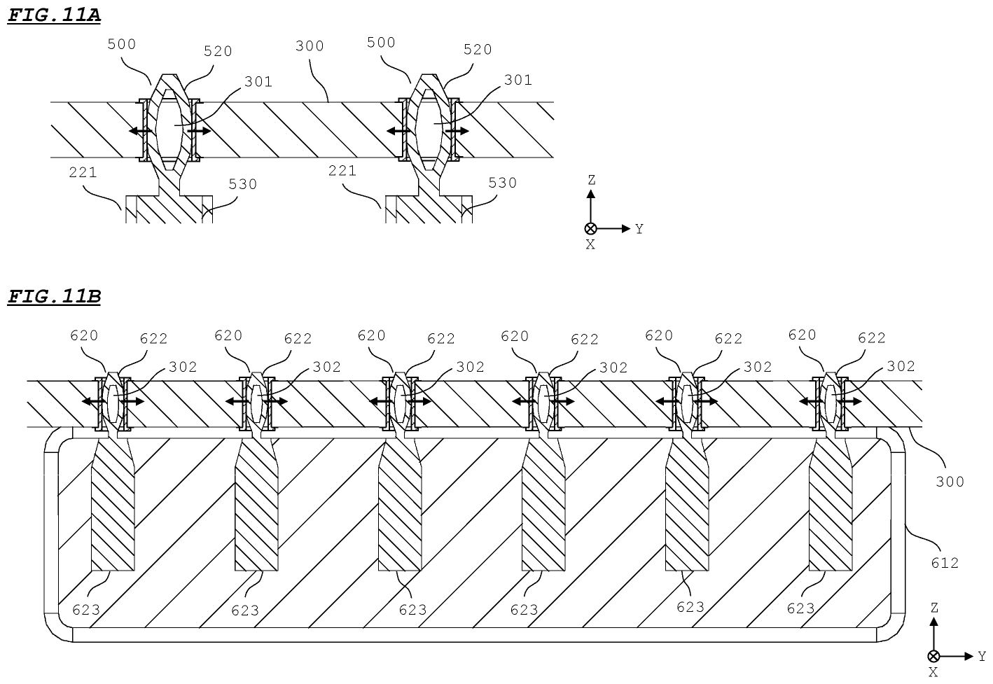

FIG. 11A is a cross-sectional view of a main part along a line A-A′ in FIG. 2 showing a state where the board connection parts 520 of one set of (two) the connection terminals 500 are inserted in corresponding one set of (two) the first through-holes 301.

The size (width) in the Y-axis direction of the board connection part 520 of each connection terminal 500 is set to be larger than the diameter of the first through-hole 301. Therefore, the board connection part 520 is present, in the first through-hole 301, in a state of being elastically deformed so as to have the same size as the diameter of the first through-hole 301, and presses the inner wall face of the first through-hole 301. Accordingly, the board connection part 520 and the inner wall face of the first through-hole 301 are in rigid contact with each other. Therefore, without performing soldering, it is possible to provide a sufficient electrical connection between the board connection part 520 and the first through-hole 301.

The board connection part 622 of each connector terminal 620 is inserted in a corresponding second through-hole 302.

FIG. 11B is a cross-sectional view of a main part along a line B-B′ in FIG. 2 showing a state where the board connection parts 622 of the six connector terminals 620 are inserted in the six second through-holes 302.

The size (width) in the Y-axis direction of the board connection part 622 of each connector terminal 620 is set to be larger than the diameter of the second through-hole 302. Therefore, the board connection part 622 is present, in the second through-hole 302, in a state of being elastically deformed so as to have the same size as the diameter of the second through-hole 302, and presses the inner wall face of the second through-hole 302. Accordingly, the board connection part 622 and the inner wall face of the second through-hole 302 are in rigid contact with each other. Therefore, without performing soldering, it is possible to provide a sufficient electrical connection between the board connection part 622 and the second through-hole 302.

The board 300 has, at respective two corner portions on the X-axis positive direction side, circular holes 303 penetrating the board 300. Further, the board 300 has, at respective two corner portions on the X-axis negative direction side, circular holes 304 penetrating the board 300.

Four corner portions of the board 300 are mounted to the two first mounting parts 230 and the two second mounting parts 250 of the hold case 200.

At the two corner portions on the X-axis negative direction side of the board 300, the connection parts 233 of the first mounting parts 230 are inserted in the holes 304 at those corner portions.

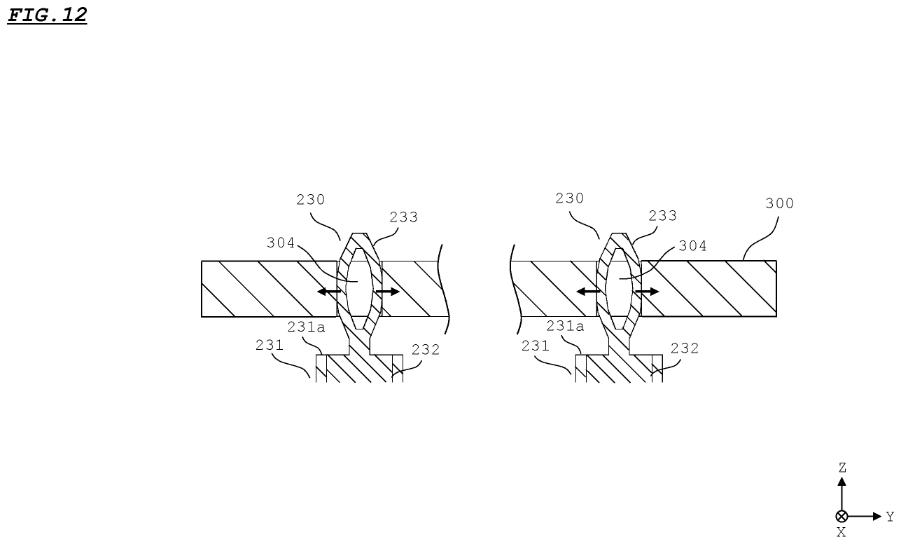

FIG. 12 is a cross-sectional view of a main part along a line C-C′ in FIG. 2 showing a state where the connection parts 233 of the two first mounting parts 230 are inserted in the two holes 304 of the board 300.

The size (width) in the Y-axis direction of the connection part 233 of each first mounting part 230 is set to be larger than the diameter of each hole 304. Therefore, the connection part 233 is present, in the hole 304, in a state of being elastically deformed so as to have the same size as the diameter of the hole 304, and presses the inner wall face of the hole 304. Accordingly, the connection part 233 and the inner wall face of the hole 304 are in rigid contact with each other, and due to the friction force caused therebetween, the two corner portions of the board 300 are fixed in the Z-axis direction.

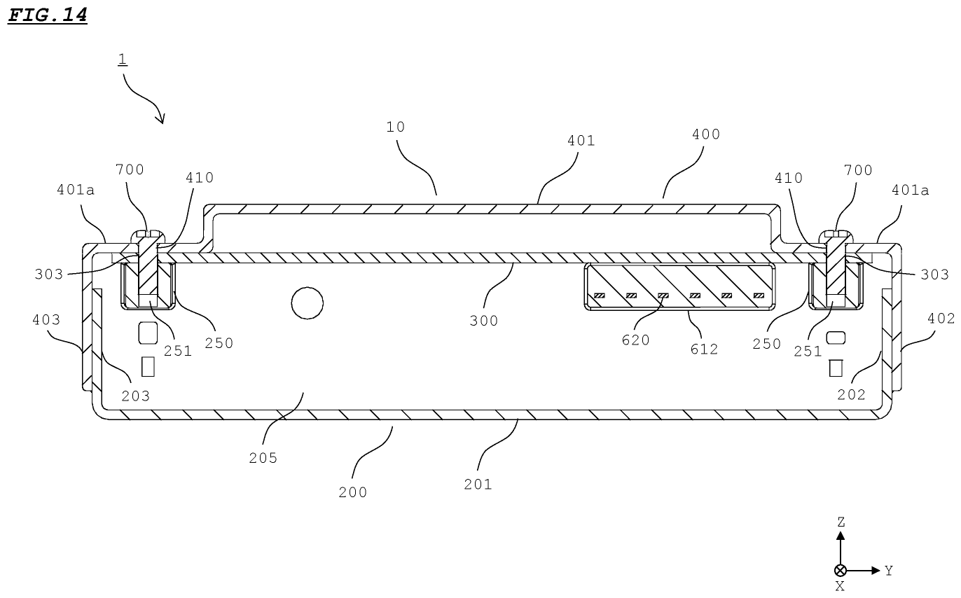

Further, two corner portions on the X-axis positive direction side of the board 300 are set at the mounting faces 250a of the two second mounting parts 250. The two holes 303 of the board 300 are aligned with the screw holes 251 of the two second mounting parts 250. The two corner portions are fixed to the two second mounting parts 250 together with the cover 400, by two screws 700 (see FIG. 14).

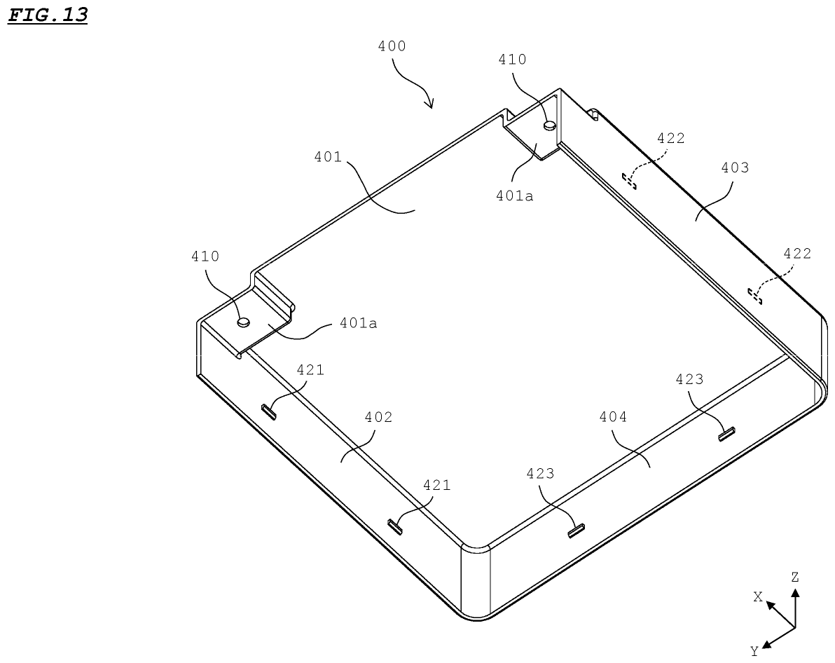

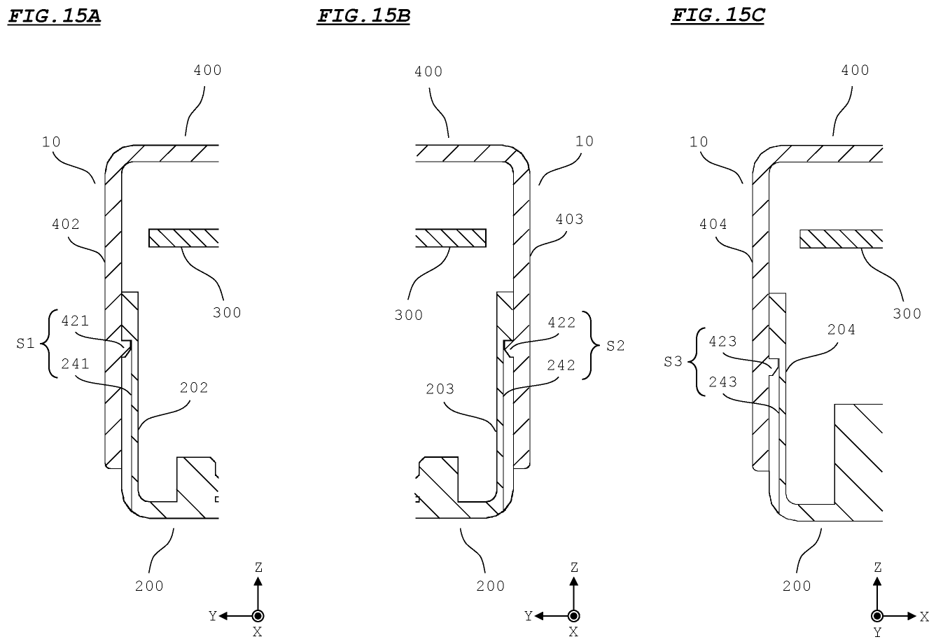

FIG. 13 is a perspective view of the cover 400. FIG. 14 is a cross-sectional view of the power storage module 1 along a line D-D′ in FIG. 1. FIG. 15A is an end view of a main part of the power storage module 1 along a Y-Z plane at an engagement position between a first projection 421 and a first recess 241. FIG. 15B is an end view of a main part of the power storage module 1 along a Y-Z plane at an engagement position between a second projection 422 and a second recess 242. FIG. 15C is an end view of a main part of the power storage module 1 along an X-Z plane at an engagement position between a third projection 423 and a third recess 243.

With reference to FIG. 1 and FIG. 13, the cover 400 is formed from a resin material such as polybutylene terephthalate (PBT) or polyphenylene sulfide (PPS). The cover 400 includes: a cover body part 401 having a quadrangular shape and covering the opening of the hold case 200 and the board 300; and a first cover lateral face part 402, a second cover lateral face part 403, and a third cover lateral face part 404 which each have a quadrangular shape and which respectively extend downwardly from a side on the Y-axis positive direction side, a side on the Y-axis negative direction side, and a side on the X-axis negative direction side, of the cover body part 401.

In the cover body part 401, two corner portions on the X-axis positive direction side are recessed in quadrangular shapes, and circular holes 410 are formed in these recesses 401a.

In the first cover lateral face part 402, at the inner face thereof, two first projections 421 each having a rib shape are provided at positions corresponding to the two first recesses 241 of the hold case 200. In the second cover lateral face part 403, at the inner face thereof, two second projections 422 each having a rib shape are provided at positions corresponding to the two second recesses 242 of the hold case 200. In the third cover lateral face part 404, at the inner face thereof, two third projections 423 each having a rib shape are provided at positions corresponding to the two third recesses 243 of the hold case 200. The width in the X-axis direction of each first projection 421 and each second projection 422 is substantially equal to the width in the X-axis direction of each first recess 241 and each second recess 242, and the width in the Y-axis direction of each third projection 423 is substantially equal to the width in the Y-axis direction of each third recess 243.

As shown in FIG. 14, with respect to the cover 400, the two recesses 401a of the cover body part 401 are in contact with the two corner portions of the board 300 set at the two second mounting parts 250, and the holes 410 in the two recesses 401a are aligned with the holes 303 in the two corner portions of the board 300 and the screw holes 251 in the two second mounting parts 250. Two screws 700 are passed through the two holes 410 in the cover 400 and the two holes 303 in the board 300, and screwed in the two screw holes 251. Accordingly, the cover 400 is fixed to the hold case 200 together with the board 300.

As shown in FIG. 15A, the first cover lateral face part 402 covers the first lateral face part 202 from the outer side of the hold case 200. The first projection 421 and the first recess 241 form a snap fit structure S1. When the cover 400 is attached to the hold case 200, the first projection 421 is fitted into the first recess 241, using the elasticity of the first cover lateral face part 402 and the first lateral face part 202. Accordingly, the first cover lateral face part 402 and the first lateral face part 202 are fixed in the in-plane direction of the outer face of the first lateral face part 202, that is, the X-Z in-plane direction.

As shown in FIG. 15B, the second cover lateral face part 403 covers the second lateral face part 203 from the outer side of the hold case 200. Due to a snap fit structure S2 formed by the second projection 422 and the second recess 242, the second cover lateral face part 403 and the second lateral face part 203 are fixed in the in-plane direction of the outer face of the second lateral face part 203, that is, the X-Z in-plane direction.

As shown in FIG. 15C, the third cover lateral face part 404 covers the third lateral face part 204 from the outer side of the hold case 200. Due to a snap fit structure S3 formed by the third projection 423 and the third recess 243, the third cover lateral face part 404 and the third lateral face part 204 are fixed in the in-plane direction of the outer face of the third lateral face part 204, that is, the Y-Z in-plane direction.

As shown in FIGS. 15A to 15C, the first lateral face part 202, the second lateral face part 203, and the third lateral face part 204 each have a height, from the bottom face part 201, that is lower than the position of the board 300. Accordingly, in the exterior case 10 formed by the hold case 200 and the cover 400, a large space can be ensured in a portion where the board 300 is disposed, by an amount caused by the absence of the first lateral face part 202, the second lateral face part 203, and the third lateral face part 204.

As shown in FIG. 1, the outer faces of the cover body part 401, the first cover lateral face part 402, and the second cover lateral face part 403 are respectively flush with an end face 205c on the Z-axis positive direction side, an end face 205d on the Y-axis positive direction side, and an end face 205e on the Y-axis negative direction side, of the fourth lateral face part 205.

Next, an assembly procedure of the power storage module 1 will be described.

First, as shown in FIG. 3, the five power storage devices 100 are attached to the holding part 210 of the hold case 200 from the Z-axis positive direction side, and are accommodated in the corresponding respective accommodation parts 211. As shown in FIG. 8, the positive electrode lead terminal 130 and the negative electrode lead terminal 140 of each power storage device 100 are connected to the terminal connection parts 510 of the respectively corresponding connection terminals 500. In each terminal connection part 510, the groove part 511 is open in the direction (the Z-axis positive direction) opposite to the attachment direction (the Z-axis negative direction) of the power storage device 100 to the hold case 200. Accordingly, at the same time when the power storage device 100 is accommodated in the accommodation part 211, the positive electrode lead terminal 130 and the negative electrode lead terminal 140 are fitted into the groove parts 511 of the respectively corresponding terminal connection parts 510.

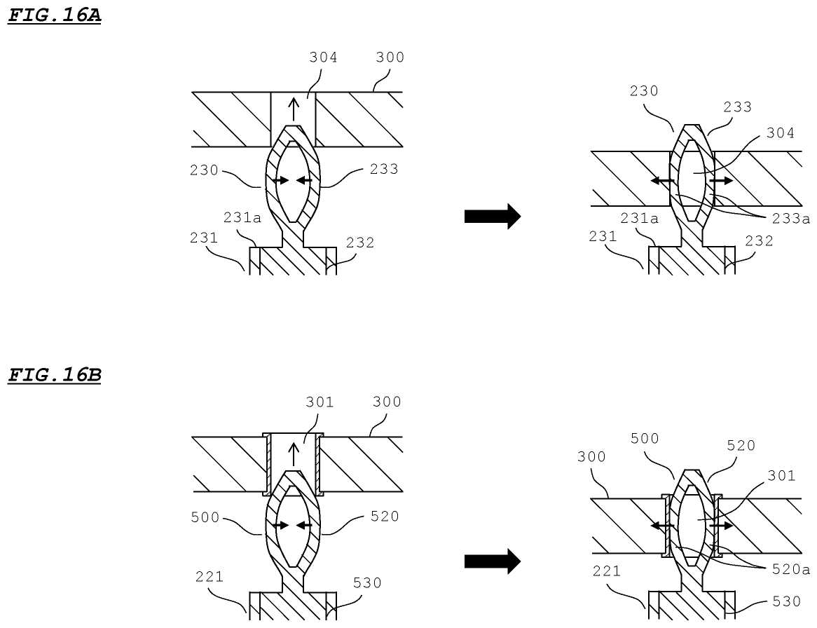

Next, as shown in FIG. 2, the board 300 is mounted to the two first mounting parts 230 and the two second mounting parts 250 of the hold case 200 from the Z-axis positive direction side. At this time, the connection parts 233 of the two first mounting parts 230 are inserted from the Z-axis negative direction side into the holes 304 at the two corner portions on the X-axis negative direction side of the board 300. As shown in FIG. 16A, a leading end portion of the connection part 233 enters the hole 304, and the connection part 233 is accordingly press-fitted into the hole 304, thereby being elastically deformed so as to reduce the size of the connection part 233, to be fitted in the hole 304. Curved portions 233a on both sides forming the ring of the connection part 233 come into contact with the inner wall face of the hole 304, to press the inner wall face.

At the same time when the board 300 is mounted to the two first mounting parts 230 and the two second mounting parts 250, ten connection terminals 500 and the six connector terminals 620 are connected to the board 300. That is, the board connection part 520 of each connection terminal 500 is inserted into a corresponding first through-hole 301 from the Z-axis negative direction side. As shown in FIG. 16B, a leading end portion of the board connection part 520 enters the first through-hole 301, and the board connection part 520 is accordingly press-fitted into the first through-hole 301, thereby being elastically deformed so as to reduce the size of the board connection part 520, to be fitted in the first through-hole 301. Curved portions 520a on both sides forming the ring of the board connection part 520 come into contact with the inner wall face of the first through-hole 301, to press the inner wall face. Accordingly, the board connection part 520 is connected to the first through-hole 301. Similarly, the board connection part 622 of each connector terminal 620 is inserted into a corresponding second through-hole 302 from the Z-axis negative direction side, to be connected to the second through-hole 302.

The positive electrode lead terminals 130 and the negative electrode lead terminals 140 of the five power storage devices 100 are electrically connected to the board 300 via the respectively corresponding connection terminals 500.

Soldering is not performed between the board connection part 520 of each connection terminal 500 and a corresponding first through-hole 301. Further, soldering is not performed between the board connection part 622 of each connector terminal 620 and a corresponding second through-hole 302.

Next, as shown in FIG. 1, the cover 400 is attached to the hold case 200 from the Z-axis positive direction side, and fixed to the hold case 200 by two screws 700 and the snap fit structures S1, S2, S3 at the three places. At this time, the two corner portions in the X-axis positive direction of the board 300 are fixed by two screws 700 so as to be sandwiched between the two second mounting parts 250 and the two recesses 401a of the cover 400 (see FIG. 14).

Then, assembly of the power storage module 1 is completed.

### Effects of the Embodiment

The power storage module 1 of the present embodiment has been described. According to the present embodiment, the following effects can be exhibited.

The power storage module 1 includes: the plurality of power storage devices 100 each having the pair of lead terminals 130, 140 (terminal) at the first end face 101 (end face); the hold case 200 (holder) in which the plurality of power storage devices 100 are held so as to be arranged such that the peripheral faces 103 of the respective power storage devices 100 are adjacent to each other; the board 300 disposed such that the plate face thereof is opposed to the peripheral faces 103 of the plurality of power storage devices 100; and the plurality of connection terminals 500 for electrically connecting the plurality of power storage devices 100 and the board 300 to each other. The board 300 includes the plurality of first through-holes 301 (through-hole) provided so as to respectively correspond to the connection terminals 500. Each of the connection terminals 500 includes the terminal connection part 510 which is connected to the positive electrode lead terminal 130 or the negative electrode lead terminal 140, and the board connection part 520 which is connected to the board 300. The board connection part 520: has a size larger than that of the first through-hole 301 and is elastically deformable; and is present, in the first through-hole 301, in a state of being elastically deformed so as to have the same size as the diameter of the first through-hole 301, and presses the inner wall face of the first through-hole 301.

With this configuration, the board connection part 520 and the inner wall face of the first through-hole 301 are in rigid contact with each other. Therefore, without performing soldering, it is possible to provide a sufficient electrical connection between the board connection part 520 and the first through-hole 301.

In the power storage module 1, the board connection part 520 has a ring shape, and is elastically deformed so as to be compressed in the radial direction of the first through-hole 301.

With this configuration, when the board connection part 520 is inserted into the first through-hole 301, the board connection part 520 is easily elastically deformed in the radial direction of the first through-hole 301. Therefore, insertion of the board connection part 520 into the first through-hole 301 becomes easy, and deformation and the like of the first through-hole 301 due to the contact with the board connection part 520 are less likely to be caused, either. Further, since the curved portions 520a on both sides forming the ring of the board connection part 520 come into contact with the inner wall face of the first through-hole 301, favorable electrical connection between the board connection part 520 and the first through-hole 301 is easy to be obtained.

In the power storage module 1, the positive electrode lead terminal 130 and the negative electrode lead terminal 140 protrude from the first end face 101. The terminal connection part 510 includes the groove part 511 into which the positive electrode lead terminal 130 or the negative electrode lead terminal 140 is fitted from a direction orthogonal to the direction in which the positive electrode lead terminal 130 or the negative electrode lead terminal 140 protrudes.

With this configuration, the positive electrode lead terminal 130 or the negative electrode lead terminal 140 can, merely by being fitted into the groove part 511, be easily connected to the terminal connection part 510.

In the power storage module 1, the groove part 511 is open in a direction opposite to the attachment direction of the power storage device 100 to the hold case 200.

With this configuration, at the same time when the power storage device 100 is attached to the hold case 200, the positive electrode lead terminal 130 or the negative electrode lead terminal 140 can be fitted into the groove part 511. Accordingly, the positive electrode lead terminal 130 or the negative electrode lead terminal 140 can be more easily connected to the terminal connection part 510.

In the power storage module 1, the hold case 200 is formed from a resin material and has the terminal holding part 220 in which the plurality of connection terminals 500 are held. Each of the connection terminals 500 includes the relay part 530 continuous between the terminal connection part 510 and the board connection part 520, the relay part 530 being embedded in the terminal holding part 220.

With this configuration, the plurality of connection terminals 500 can be rigidly held by the terminal holding part 220.

In the power storage module 1, the terminal holding part 220 includes the plurality of columnar parts 221 in which the relay parts 530 are respectively embedded. The plurality of columnar parts 221 are arranged with an interval therebetween in a direction in which the plurality of power storage devices 100 are arranged. With this configuration, the amount of the resin used in the terminal holding part 220 can be suppressed, and reduction in weight and reduction of cost of the hold case 200 can be realized.

In the power storage module 1, the hold case 200 has the first mounting parts 230 to which the board 300 is mounted. The board 300 includes the hole 304 provided so as to correspond to each first mounting part 230. The first mounting part 230 includes the connection part 233 which is connected to the board 300. The connection part 233: has a size larger than the diameter of the hole 304 and is elastically deformable; and is present, in the hole 304, in a state of being elastically deformed so as to have the same size as the diameter of the hole 304, and presses the inner wall face of the hole 304.

With this configuration, the board 300 can be fixed to the first mounting part 230 without using a fixing tool such as a screw.

In the power storage module 1, the hold case 200 has the second mounting parts 250 to which the board 300 is mounted by screws 700.

With this configuration, the board 300 is rigidly fixed to the second mounting parts 250 by the screws 700. Accordingly, the board 300 is less likely to be detached from the first mounting parts 230, either, as well as from the second mounting parts 250.

In the power storage module 1, the hold case 200 includes: the bottom face part 201 having a quadrangular shape and having the holding part 210 in which the plurality of power storage devices 100 are held; the first lateral face part 202 and the second lateral face part 203 which stand from one pair of two sides, that are parallel to each other, of the bottom face part 201; and the third lateral face part 204 and the fourth lateral face part 205 which stand from the other pair of two sides, that are parallel to each other, of the bottom face part 201. The hold case 200 has a face, opposed to the bottom face part 201, being an opening. The board 300 is disposed on a side opposite to the bottom face part 201 with respect to the plurality of power storage devices 100. The power storage module 1 further includes the cover 400 which is attached to the hold case 200. The cover 400 includes: the cover body part 401 having a quadrangular shape and covering the opening of the hold case 200 and the board 300; and the first cover lateral face part 402 and the second cover lateral face part 403 respectively covering the first lateral face part 202 and the second lateral face part 203 from the outer side of the hold case 200.

With this configuration, the exterior case 10 housing the plurality of power storage devices 100 and the board 300 can be formed by the hold case 200 and the cover 400, and the plurality of power storage devices 100 and the board 300 can be protected by the exterior case 10.

Further, since the first lateral face part 202 and the second lateral face part 203 are respectively covered by the first cover lateral face part 402 and the second cover lateral face part 403, the strength of the exterior case 10 as a whole is increased. In addition, water is less likely to enter the exterior case 10.

In the power storage module 1, the first lateral face part 202 and the first cover lateral face part 402 are fixed by the snap fit structure S1 composed of: the first projection 421 provided in one of the first lateral face part 202 and the first cover lateral face part 402; and the first recess 241 provided in the other of the first lateral face part 202 and the first cover lateral face part 402. The second lateral face part 203 and the second cover lateral face part 403 are fixed by the snap fit structure S2 composed of: the second projection 422 provided in one of the second lateral face part 203 and the second cover lateral face part 403; and the second recess 242 provided in the other of the second lateral face part 203 and the second cover lateral face part 403.

With this configuration, the cover 400 can be fixed to the hold case 200 by the snap fit structure S1 provided between the first lateral face part 202 and the first cover lateral face part 402 and the snap fit structure S2 provided between the second lateral face part 203 and the second cover lateral face part 403. Therefore, the number of screws 700 to be used in order to ensure a sufficient coupling strength between the cover 400 and the hold case 200 can be reduced. For example, in the present embodiment, a sufficient coupling strength between the cover 400 and the hold case 200 can be ensured merely by using two screws 700.

In the power storage module 1, the first lateral face part 202 and the second lateral face part 203 each have a height, from the bottom face part 201, that is lower than the position of the board 300.

With this configuration, in the exterior case 10, a large space can be ensured in a portion where the board 300 is disposed, by an amount caused by the absence of the first lateral face part 202 and the second lateral face part 203.

In the power storage module 1, the cover 400 further includes the third cover lateral face part 404 covering the third lateral face part 204 from the outer side of the hold case 200. The fourth lateral face part 205 includes the connector 600 (output part) for outputting electric power of the plurality of power storage devices 100 to the outside. The connector 600 protrudes from the outer face of the fourth lateral face part 205, and is connected to an external terminal.

With this configuration, since the third lateral face part 204 is covered by the third cover lateral face part 404, the strength of the exterior case 10 as a whole is more increased. In addition, water is further less likely to enter the exterior case 10. Further, since the fourth lateral face part 205 is not covered by the cover 400, the cover 400 does not obstruct the connector 600 serving as an output part.

In the power storage module 1, the third lateral face part 204 and the third cover lateral face part 404 are fixed by the snap fit structure S3 composed of: the third projection 423 provided in one of the third lateral face part 204 and the third cover lateral face part 404; and the third recess 243 provided in the other of the third lateral face part 204 and the third cover lateral face part 404.

With this configuration, the cover 400 can be fixed to the hold case 200 by the snap fit structure S3 provided between the third lateral face part 204 and the third cover lateral face part 404. Therefore, the coupling strength between the cover 400 and the hold case 200 can be more increased.

In the power storage module 1, the third lateral face part 204 has a height, from the bottom face part 201, that is lower than the position of the board 300.

With this configuration, in the exterior case 10, a large space can be ensured in a portion where the board 300 is disposed, by an amount caused by the absence of the third lateral face part 204.

In the power storage module 1, the board 300 includes the plurality of first through-holes 301 provided so as to respectively correspond to the connection terminals 500, and each of the connection terminals 500 includes the board connection part 520 having a size larger than the diameter of each first through-hole 301 and being elastically deformable. When the plurality of connection terminals 500 are to be connected to the board 300, the board connection part 520 is press-fitted into the first through-hole 301, to be elastically deformed so as to reduce the size of the board connection part 520 in the radial direction of the first through-hole 301, to be brought into contact with the inner wall face of the first through-hole 301.

According to this manufacturing method, without performing soldering, it is possible to provide a sufficient electrical connection between the board connection part 520 and the first through-hole 301, and thus, it is possible to omit the soldering step.

In the power storage module 1, the hold case 200 has the first mounting parts 230 (mounting part) to which the board 300 is mounted, and the board 300 includes the holes 304 provided so as to correspond to the first mounting parts 230. Each first mounting part 230 includes the connection part 233 having a size larger than the diameter of each hole 304 and being elastically deformable. When the board 300 is to be mounted to the first mounting part 230, the connection part 233 is press-fitted into the hole 304, to be elastically deformed so as to reduce the size of the connection part 233 in the radial direction of the hole 304, to be brought into contact with the inner wall face of the hole 304.

According to this manufacturing method, the board 300 can be fixed to the first mounting part 230 without using a fixing tool such as a screw.

<Modification>

Although an embodiment of the present invention has been described, the present invention is not limited to the above embodiment. In addition, application examples of the present invention can also be modified in various ways, in addition to the above embodiment.

For example, in the embodiment above, the plurality of power storage devices 100 are held so as to be arranged, by the hold case 200 having a box shape. However, the holder in which the power storage devices 100 are held need not necessarily have a box shape, and for example, the holder may be composed only of the holding part 210 included in the hold case 200.

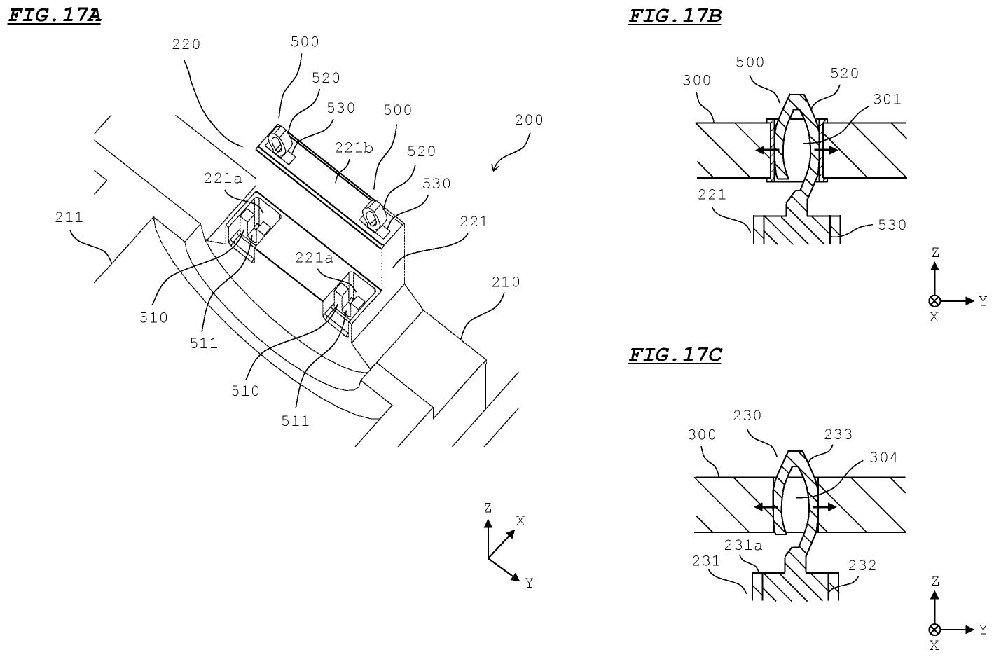

In the embodiment above, the terminal holding part 220 is composed of a plurality of (ten) columnar parts 221 in which the relay parts 530 of the connection terminals 500 are respectively embedded one by one. However, the configuration of the terminal holding part 220 is not limited to the configuration above. For example, as shown in FIG. 17A, the terminal holding part 220 may be composed of a plurality of (five) columnar parts 221 in each of which the relay parts 530 of two connection terminals 500 are embedded, and which are provided, one by one, for the respective power storage devices 100, i.e., the respective accommodation parts 211. Alternatively, the terminal holding part 220 is not divided into a plurality of columnar parts 221, but instead, may have a configuration in which the relay parts 530 of all the connection terminals 500 are embedded in one wall-shaped part extending in the direction in which the power storage devices 100 are arranged.

In the embodiment above, the board connection part 520 of each connection terminal 500 is formed in a ring shape. However, the board connection part 520 may have another shape as long as the board connection part 520: has a size larger than that of the first through-hole 301 and is elastically deformable; and is present, in the first through-hole 301, in a state of being elastically deformed so as to have the same size as the diameter of the first through-hole 301, and presses the inner wall face of the first through-hole 301. For example, as shown in FIG. 17B, the board connection part 520 may have a shape close to a letter C. Similarly, the connection part 233 of the first mounting part 230 may also have another shape as long as the connection part 233: has a size larger than the diameter of the hole 304 and is elastically deformable; and is present, in the hole 304, in a state of being elastically deformed so as to have the same size as the diameter of the hole 304, and presses the inner wall face of the hole 304. For example, as shown in FIG. 17C, the connection part 233 may have a shape close to a letter C. The shape of the board connection part 622 of the connector terminal 620 may also be changed to another shape such as a shape in FIG. 17B.

In the embodiment above, as shown in FIG. 12, a slight gap, e.g., a gap of about 1 mm, is caused between the board 300 and the leading end face 231a of the post part 231 of the first mounting part 230. However, a configuration in which the leading end face 231a of the post part 231 is in contact with the board 300 may be adopted.

In the embodiment above, ten connection terminals 500 are provided to the hold case 200. However, the number of the connection terminals 500 may be changed as appropriate, according to the number of the power storage devices 100, for example. Similarly, the numbers of the first mounting parts 230 and the second mounting parts 250 provided to the hold case 200 are not limited to two, and may be changed as appropriate, according to the shape or size of the board 300, for example.

In the embodiment above, the cover 400 is configured to include the first cover lateral face part 402, the second cover lateral face part 403, and the third cover lateral face part 404. However, a configuration in which the cover 400 includes the first cover lateral face part 402 and the second cover lateral face part 403 and does not include the third cover lateral face part 404 may be adopted. Alternatively, a configuration in which the cover 400 includes the third cover lateral face part 404 and does not include the first cover lateral face part 402 and the second cover lateral face part 403 may be adopted.

In the embodiment above, the first recess 241 is formed in the first lateral face part 202, and the first projection 421 is formed in the first cover lateral face part 402. However, a first projection may be formed in the first lateral face part 202 and a first recess may be formed in the first cover lateral face part 402. Similarly, a second projection and a third projection may be respectively formed in the second lateral face part 203 and the third lateral face part 204, and a second recess and a third recess may be formed in the second cover lateral face part 403 and the third cover lateral face part 404. Further, a configuration in which the snap fit structure S1 between the first lateral face part 202 and the first cover lateral face part 402, and the snap fit structure S2 between the second lateral face part 203 and the second cover lateral face part 403 are provided, and the snap fit structure S3 between the third lateral face part 204 and the third cover lateral face part 404 is not provided may be adopted. Alternatively, a configuration in which the snap fit structure S3 is provided and the snap fit structure S1 and the snap fit structure S2 are not provided may be adopted.

In the embodiment above, the heights from the bottom face part 201 of the first lateral face part 202, the second lateral face part 203, and the third lateral face part 204 are set to be lower than the position of the board 300. However, the heights from the bottom face part 201 of the first lateral face part 202, the second lateral face part 203, and the third lateral face part 204 may be set to be higher than the position of the board 300.

In the embodiment above, the connector 600 is formed integrally with the fourth lateral face part 205 of the hold case 200. However, a connector separate from the fourth lateral face part 205 may be mounted to the fourth lateral face part 205. Further, an output part having a configuration different from that of a connector, e.g., an output part implemented by a bus bar to serve as an external output terminal, may be provided to the fourth lateral face part 205.

In the embodiment above, in the terminal connection part 510 of the connection terminal 500, the groove part 511 into which the positive electrode lead terminal 130 or the negative electrode lead terminal 140 of the power storage device 100 is fitted is formed. However, the terminal connection part 510 may be connected to the positive electrode lead terminal 130 or the negative electrode lead terminal 140, by a configuration other than the groove part 511.

In the embodiment above, five power storage devices 100 are used in the power storage module 1. However, not limited thereto, another number of the power storage devices 100 may be used in the power storage module 1.

In the embodiment above, an electric double layer capacitor is used as the power storage device 100. However, as the power storage device 100, instead of the capacitor, a lithium ion secondary battery in which an active material of the positive electrode is a lithium transition metal oxide such as lithium cobalt oxide and an active material of the negative electrode is a carbon material may be used, for example. Further, instead of such a nonaqueous electrolyte secondary battery, the power storage device 100 may be a secondary battery other than a nonaqueous electrolyte secondary battery, or may be a primary battery.

In the embodiment above, the power storage device 100 is configured such that the positive electrode lead terminal 130 and the negative electrode lead terminal 140 project from the first end face 101. However, the power storage device 100 may be configured such that a terminal part other than the lead terminals 130, 140, e.g., one terminal part that is shorter and has a diameter larger than the lead terminals 130, 140, projects from the first end face 101.

Other than this, various changes can be made as appropriate to the embodiment of the present invention, within the scope of the technical idea described in the claims.

### INDUSTRIAL APPLICABILITY

The present invention is useful for power storage modules that are used in various types of electronic apparatuses, electric apparatuses, industrial apparatuses, electrical equipment for vehicles, and the like.

### DESCRIPTION OF THE REFERENCE CHARACTERS

1 power storage module
100 power storage device
101 first end face (end face)
103 peripheral face
130 positive electrode lead terminal (terminal)
140 negative electrode lead terminal (terminal)
200 hold case (holder)
201 bottom face part
202 first lateral face part
203 second lateral face part
204 third lateral face part
205 fourth lateral face part
210 holding part
220 terminal holding part
221 columnar part
230 first mounting part (mounting part)
233 connection part
241 first recess
242 second recess
243 third recess
250 second mounting part
300 board
301 first through-hole (through-hole)
304 hole
400 cover
401 cover body part
402 first cover lateral face part
403 second cover lateral face part
404 third cover lateral face part
421 first projection
422 second projection
423 third projection
500 connection terminal
510 terminal connection part
511 groove part
520 board connection part
530 relay part
600 connector (output part)
700 screw
S1 snap fit structure
S2 snap fit structure
S3 snap fit structure

1. A power storage module comprising:
a plurality of power storage devices each having a terminal at an end face thereof;
a holder in which the plurality of power storage devices are held so as to be arranged such that peripheral faces of the respective power storage devices are adjacent to each other;
a board disposed such that a plate face thereof is opposed to the peripheral faces of the plurality of power storage devices; and
a plurality of connection terminals for electrically connecting the plurality of power storage devices and the board to each other, wherein
the board includes a plurality of through-holes provided so as to respectively correspond to the connection terminals,
each of the connection terminals includes a terminal connection part which is connected to the terminal, and a board connection part which is connected to the board, and
the board connection part
has a size larger than a diameter of each through-hole and is elastically deformable, and
is present, in the through-hole, in a state of being elastically deformed so as to have a same size as the diameter of the through-hole, and presses an inner wall face of the through-hole.

2. The power storage module according to claim 1, wherein
the board connection part has a ring shape and is elastically deformed so as to be compressed in a radial direction of the through-hole.

3. The power storage module according to claim 1, wherein
the terminal protrudes from the end face, and
the terminal connection part includes a groove part into which the terminal is fitted from a direction orthogonal to a direction in which the terminal protrudes.

4. The power storage module according to claim 3, wherein
the groove part is open in a direction opposite to an attachment direction of each power storage device to the holder.

5. The power storage module according to claim 1, wherein
the holder is formed from a resin material and has a terminal holding part in which the plurality of connection terminals are held, and
each of the connection terminals
includes a relay part continuous between the terminal connection part and the board connection part,
the relay part being embedded in the terminal holding part.

6. The power storage module according to claim 5, wherein
the terminal holding part includes a plurality of columnar parts in which the relay parts are respectively embedded, and
the plurality of columnar parts are arranged with an interval therebetween in a direction in which the plurality of power storage devices are arranged.

7. The power storage module according to claim 1, wherein
the holder has a first mounting part to which the board is mounted,
the board includes a hole provided so as to correspond to the first mounting part,
the first mounting part includes a connection part which is connected to the board, and
the connection part
has a size larger than a diameter of the hole and is elastically deformable, and
is present, in the hole, in a state of being elastically deformed so as to have a same size as the diameter of the hole, and presses an inner wall face of the hole.

8. The power storage module according to claim 7, wherein
the holder has a second mounting part to which the board is mounted by a screw.

9. The power storage module according to claim 1, wherein
the holder
includes:
a bottom face part having a quadrangular shape and having a holding part in which the plurality of power storage devices are held;
a first lateral face part and a second lateral face part which stand from one pair of two sides, that are parallel to each other, of the bottom face part; and
a third lateral face part and a fourth lateral face part which stand from another pair of two sides, that are parallel to each other, of the bottom face part, and
has a face, opposed to the bottom face part, being an opening,
the board is disposed on a side opposite to the bottom face part with respect to the plurality of power storage devices,
the power storage module further includes a cover which is attached to the holder, and
the cover includes
a cover body part having a quadrangular shape and covering the opening of the holder and the board, and
a first cover lateral face part and a second cover lateral face part respectively covering the first lateral face part and the second lateral face part from an outer side of the holder.

10. The power storage module according to claim 9, wherein
the first lateral face part and the first cover lateral face part are fixed by a snap fit structure composed of: a first projection provided in one of the first lateral face part and the first cover lateral face part; and a second recess provided in another of the first lateral face part and the first cover lateral face part, and
the second lateral face part and the second cover lateral face part are fixed by a snap fit structure composed of: a second projection provided in one of the second lateral face part and the second cover lateral face part; and a second recess provided in another of the second lateral face part and the second cover lateral face part.

11. The power storage module according to claim 9, wherein
the first lateral face part and the second lateral face part each have a height, from the bottom face part, that is lower than a position of the board.

12. The power storage module according to claim 9, wherein
the cover further includes a third cover lateral face part covering the third lateral face part from the outer side of the holder, and
the fourth lateral face part has an output part for outputting electric power of the plurality of power storage devices to outside.

13. The power storage module according to claim 12, wherein
the output part includes a connector protruding from an outer face of the fourth lateral face part and to be connected to an external terminal.

14. The power storage module according to claim 12, wherein
the third lateral face part and the third cover lateral face part are fixed by a snap fit structure composed of: a third projection provided in one of the third lateral face part and the third cover lateral face part; and a third recess provided in another of the third lateral face part and the third cover lateral face part.

15. The power storage module according to claim 12, wherein
the third lateral face part has a height, from the bottom face part, that is lower than a position of the board.

16. A manufacturing method for a power storage module,
the power storage module including
a plurality of power storage devices each having a terminal at an end face thereof,
a holder in which the plurality of power storage devices are held so as to be arranged such that peripheral faces of the respective power storage devices are adjacent to each other,
a board disposed such that a plate face thereof is opposed to the peripheral faces of the plurality of power storage devices, and
a plurality of connection terminals for electrically connecting the plurality of power storage devices and the board to each other,
wherein
the board includes a plurality of through-holes provided so as to respectively correspond to the connection terminals,
each of the connection terminals includes a board connection part having a size larger than a diameter of each through-hole and being elastically deformable, and
when the plurality of connection terminals are to be connected to the board, the board connection part is press-fitted into the through-hole, to be elastically deformed so as to reduce the size of the board connection part in a radial direction of the through-hole, to be brought into contact with an inner wall face of the through-hole.

17. The manufacturing method for the power storage module according to claim 16, wherein
the holder has a mounting part to which the board is mounted,
the board includes a hole provided so as to correspond to the mounting part,
the mounting part includes a connection part having a size larger than a diameter of the hole and being elastically deformable, and
when the board is to be mounted to the mounting part, the connection part is press-fitted into the hole, to be elastically deformed so as to reduce the size of the connection part in a radial direction of the hole, to be brought into contact with an inner wall face of the hole.
